(19) United States
(12) Patent Application Publication
(10) Pub. No.: US 2012/0288244 A1
(43) Pub. Date: Nov. 15, 2012

(54) SHIELDING STRUCTURE FOR OPTICAL SUB-ASSEMBLY FOR TRANSCEIVERS

(75) Inventors: CHIN-TSUNG WU, TAIPEI (TW); KUEI-HSIANG CHENG, TAIPEI (TW)

(73) Assignee: EZCONN CORPORATION, TAIPEI (TW)

(21) Appl. No.: 13/106,070

(22) Filed: May 12, 2011

(51) Int. Cl. G02B 6/36

(52) U.S. Cl. 385/94

(57) ABSTRACT

A shielding structure for optical sub-assembly for transceivers includes a housing and a movable board. The housing has a bottom board, a front end board upward extending from a front end of the bottom board and two sideboards upward extending from a left side and a right side of the bottom board. The movable cover includes a plate main body. The plate main body has a connection end connected with the front end board of the housing and a press end opposite to the connection end. The movable cover further includes two sideboards downward extending from a left side and a right side of the plate main body. When installing the optical sub-assembly for transceivers into the shielding structure, the press end of the movable cover is pressed down until the movable cover is engaged with the housing in a closed state so as to avoid electromagnetic interference.

### BACKGROUND OF THE INVENTION

1. Field of the Invention

The present invention relates to a shielding structure, and more particularly to a shielding structure for optical sub-assembly for transceivers.

2. Description of the Related Art

In an optical fiber communication system, optical sub-assembly for transceivers is an important medium for conversion between optical signals and electrical signals. The optical sub-assembly for transceivers related to the present invention can be classified into bi-direction optical sub-assembly (BOSA) capable of receiving bi-direction signals in the same optical fiber and tri-direction optical sub-assembly (TRI-DI OSA) capable of receiving tri-direction signals in the same optical fiber.

As shown in FIG. 1, taking the tri-direction optical sub-assembly as an example, the tri-direction optical sub-assembly 10 is fixed on a circuit board 11 by means of soldering. The tri-direction optical sub-assembly 10 is not equipped with any shielding member. As a result, the analog signal receiver and digital signal receiver 43 of the tri-direction optical sub-assembly is interfered with by external electromagnetic wave to extensively cause electromagnetic interference (EMI) with the electronic circuits on the circuit board 11. This will lead to interference with the communication and needs to be overcome.

### SUMMARY OF THE INVENTION

A primary object of the present invention is to provide a shielding structure for optical sub-assembly for transceivers, which can avoid electromagnetic interference of external electromagnetic wave with the optical sub-assembly for transceivers.

To achieve the above and other objects, the shielding structure for optical sub-assembly for transceivers of the present invention includes a housing and a movable board. The housing has a bottom board, a front end board upward extending from a front end of the bottom board and two sideboards upward extending from a left side and a right side of the bottom board. The movable cover includes a plate main body. The plate main body has a connection end connected with the front end board of the housing and a press end opposite to the connection end. The movable cover further includes two sideboards downward extending from a left side and a right side of the plate main body. When installing the optical sub-assembly for transceivers into the shielding structure, the press end of the movable cover is pressed down until the movable cover is engaged with the housing in a closed state.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view showing that a conventional optical transceiver is connected to a circuit board;

FIG. 2 is a perspective view of the shielding structure of the present invention in an open state;

FIG. 3 is a perspective view of the shielding structure of the present invention in a closed state;

FIG. 4 is a sectional view taken along line 4-4 of FIG. 3;

FIGS. 5A and 5B show a method of installing the shielding structure of the present invention onto the optical transceiver; and

FIG. 6 is a perspective view showing that the optical transceiver with the shielding structure of the present invention according to FIG. 5B is connected to a circuit board.

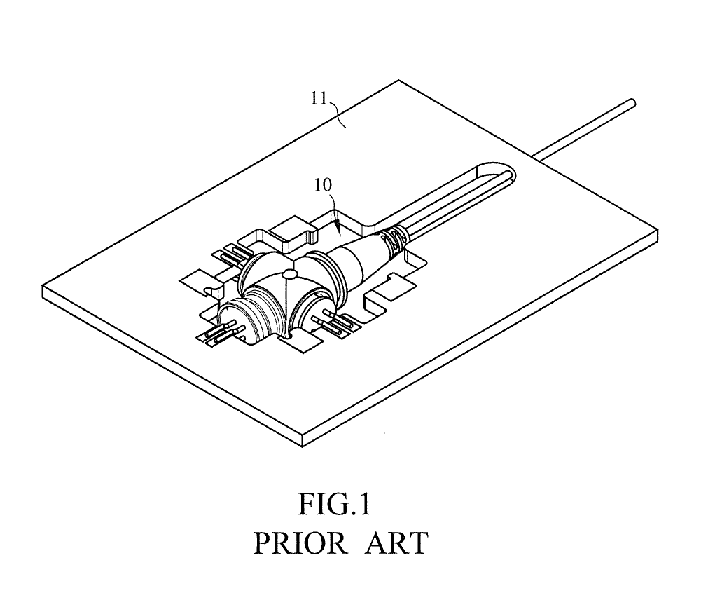

### DETAILED DESCRIPTION OF THE PREFERRED EMBODIMENT

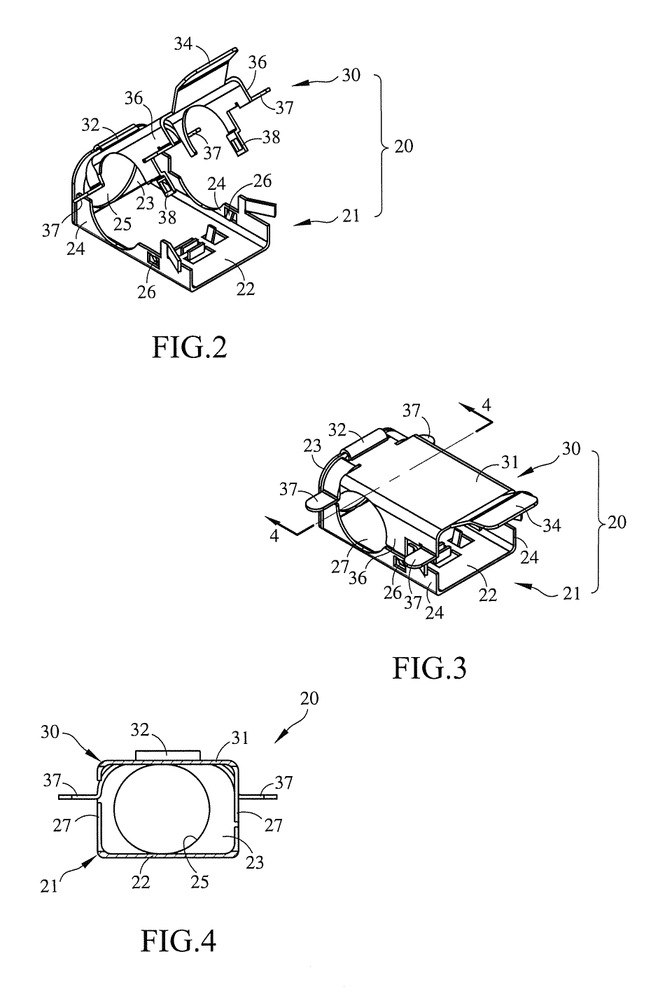

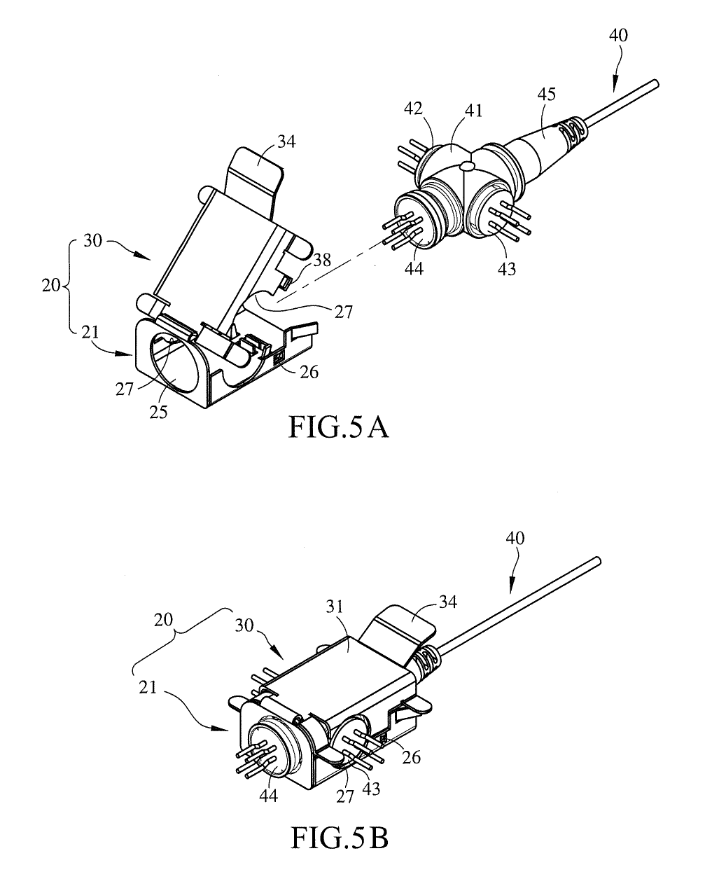

Please refer to FIGS. 2 to 4. The shielding structure 20 of the present invention is applicable to various optical sub-assemblies for transceivers, such as BOSA and TRI-DI OSA. The shielding structure 20 includes a housing 21 and a movable cover 30. The housing 21 has a bottom board 22, a front end board 23 upward extending from a front end of the bottom board 22 and two sideboards 24 upward extending from a left side and a right side of the bottom board 22.

The front end board 23 is formed with a connection port 25 with a diameter approximately equal to that of the digital signal transmitter 44 of the tri-direction optical sub-assembly 40 (as shown in FIG. 5A). Accordingly, the digital signal transmitter 44 can pass through the connection port 25.

The movable cover 30 includes a plate main body 31. The plate main body 31 has a connection end 32 connected with a top end of the front end board 23 of the housing 21 and a press end 34 opposite to the connection end 32. The press end 34 serves as a force application point of the movable cover 30. When a slight force is manually applied to the press end 34, the movable cover 30 is moved downward from an open position as shown in FIG. 2 to a closed position as shown in FIG. 3. The movable cover 30 further includes two sideboards 36 downward extending from a left side and a right side of the plate main body 31. In practice, the movable cover 30 and the housing 21 can be integrally formed.

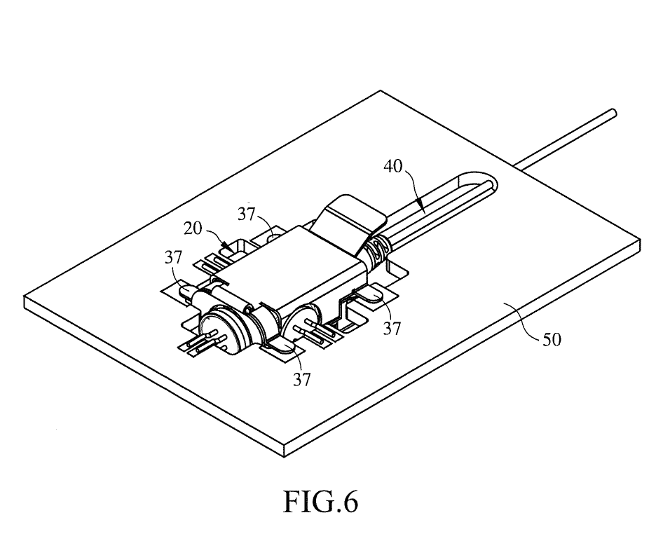

The movable cover 30 further includes multiple auxiliary legs 37 outward extending from the sideboards 36. The auxiliary legs 37 can be soldered on the circuit board 50 to securely connect the shielding structure 20 with the circuit board 50 so as to quickly conduct the interference electromagnetic wave to the grounding terminal of the circuit board 50 as shown in FIG. 6.

A latch section 38 outward extends from the sideboard 36 of the movable cover 30. The sideboard 24 of the housing 21 is formed with a projection section 26 corresponding to the latch section 38. When the movable cover 30 is closed to the housing 21, the latch section 38 is latched with the projection section 26.

In general, BOSA is a T-shaped structure, while TRI-DI OSA is a cross-shaped structure. In order to apply the shielding structure 20 of the present invention to both the BOSA and TRI-DI OSA, it is necessary to form a connection port 27 through a sideboard 36 of the movable cover 30 and a sideboard 24 of the housing 21 corresponding to the analog/digital signal receiver of the BOSA or a connection port 27 through each sideboard 36 of the movable cover 30 and each sideboard 24 of the housing 21 corresponding to the analog signal receiver and digital signal receiver of the TRI-DI OSA.

FIGS. 5A and 5B show a method of installing the shielding structure 20 of the present invention onto the optical sub-assembly for transceivers. Taking a tri-direction optical transmitter 40 as an example of the conventional tri-direction optical sub-assembly, the tri-direction optical transmitter 40 has a main housing 41 in the form of across structure for receiving an analog signal receiver 42, a digital signal receiver 43, a digital signal transmitter 44 and an optical fiber module 45 for transmitting optical signals. The first step of installation is to install the tri-direction optical transmitter 40 into the shielding structure 20 to pass the digital signal transmitter 44 through the connection port 25, the analog signal receiver 42 through the connection port 27 and the digital signal receiver 43 through the connection port 27 as shown in FIG. 5A.

Then, a downward force is applied to the press end 35 until the latch section 38 is latched with the projection section 26. Under such circumstance, the movable cover 30 is engaged with the housing 21 in a closed state as shown in FIG. 5B.

Referring to FIG. 6, after the tri-direction optical transmitter 40 is installed into the shielding structure 20, the multiple auxiliary legs 37 are soldered on the circuit board 50 to securely connect the shielding structure 20 with the circuit board 50 so as to quickly conduct the interference electromagnetic wave to the grounding terminal of the circuit board 50.

The shielding structure 20 completely shields the tri-direction optical transmitter 40 so that the electromagnetic interference can be effectively avoided.

The above embodiment is only used to illustrate the present invention, not intended to limit the scope thereof. It is understood that many changes or modifications of the above embodiment can be made by those who are skilled in this field without departing from the spirit of the present invention. The scope of the present invention is limited only by the appended claims.

What is claimed is:

1. A shielding structure for optical sub-assembly for transceivers, comprising:
a housing having a bottom board, a front end board upward extending from a front end of the bottom board and two sideboards upward extending from a left side and a right side of the bottom board; and
a movable cover including a plate main body, the plate main body having a connection end connected with a top end of the front end board of the housing and a press end opposite to the connection end, the movable cover further including two sideboards downward extending from a left side and a right side of the plate main body, whereby when installing the optical sub-assembly for transceivers into the housing, a downward force is applied to the press end until the movable cover is engaged with the housing in a closed state so as to avoid electromagnetic interference.

2. The shielding structure as claimed in claim 1, wherein the movable cover further includes multiple auxiliary legs outward extending from the sideboards of the movable cover.

3. The shielding structure as claimed in claim 1, wherein a latch section outward extends from the sideboard of the movable cover and the sideboard of the housing is formed with a projection section corresponding to the latch section, whereby when the movable cover is closed to the housing, the latch section is latched with the projection section.

4. The shielding structure as claimed in claim 1, wherein the front end board is formed with a connection port.

5. The shielding structure as claimed in claim 4, wherein a connection port is formed through the sideboard of the movable cover and the sideboard of the housing.
